(19) United States
(12) Patent Application Publication
(10) Pub. No.: US 2016/0080594 A1
(43) Pub. Date: Mar. 17, 2016

(54) IMAGE PROCESSING APPARATUS THAT CAUSES CLIENT TERMINAL TO PERFORM APPROPRIATE DISPLAY, METHOD OF CONTROLLING THE SAME, AND STORAGE MEDIUM

(71) Applicant: CANON KABUSHIKI KAISHA, Tokyo (JP)

(72) Inventor: Shigeki Kuroda, Yokohama-shi (JP)

(21) Appl. No.: 14/849,956

(22) Filed: Sep. 10, 2015

(30) Foreign Application Priority Data
Sep. 12, 2014 (JP) 2014-186228

(51) Int. Cl. H04N 1/00

(52) U.S. Cl. CPC H04N 1/00514; H04N 1/00493; H04N 1/00474; H04N 2201/0094

(57) ABSTRACT

An image processing apparatus that is capable of causing a client terminal to perform appropriate display based on setting information of a user stored in the image processing apparatus. The image processing apparatus transmits Web page information to the client terminal based on access from the client terminal. The user setting information is on display and is set in advance by each user. The Web page information is generated based on access from the client terminal used by a user, based on setting information associated with the user out of the stored user setting information. The generated Web page information is transmitted to the client terminal.

### BACKGROUND OF THE INVENTION

1. Field of the Invention

The present invention relates to an image processing apparatus that causes a client terminal to perform appropriate display, a method of controlling the image processing apparatus, and a storage medium, and more particularly to an image processing apparatus that appropriately sets a language to be used for display on an operation screen, a method of controlling the image processing apparatus, and a storage medium.

2. Description of the Related Art

In an image processing apparatus, such as an MFP (Multi-Function Peripheral) equipped with functions of various types, setting items to be set by a user for performing various operations have diversified. In an image processing apparatus shared by a plurality of users, setting information of setting items is managed on a user-by-user basis. The image processing apparatus stores, on a user-by-user basis, setting information of setting items that are not changed frequently after the time of initially setting them, such as setting information of a language to be used for display on an operation screen of the image processing apparatus. The stored setting information is set to the image processing apparatus when each user has logged into the image processing apparatus. This causes the language associated with the setting information of the user who has logged into the image processing apparatus to be used for display on the operation screen of the image processing apparatus.

Incidentally, in the image processing apparatus, when data is transmitted and received between the image processing apparatus and a client PC or the like which is connected to a network via a LAN (Local Area Network), a browser application, such a remote user interface, is used. The client PC displays various information of Web services provided by the image processing apparatus e.g. via the remote user interface. In the remote user interface, a language to be used for display on the client PC is set based on different information from the setting information stored in the image processing apparatus. For example, a language set by a Web browser of the client PC or a language associated with information acquired from the client PC concerning a language displayable by the Web browser of the client PC is displayed (see e.g. Japanese Patent Laid-Open Publication No. 2002-324017).

However, the setting information stored in the image processing apparatus and the setting information used by the remote user interface are not associated with each other. Therefore, for example, in a case where a language set based on the setting information stored in the image processing apparatus is different from a language set via the remote user interface, when a user accesses the image processing apparatus via the remote user interface, priority is given to the setting in the remote user interface, so that it is impossible to use the setting information of the user stored in the image processing apparatus. This sometimes causes a language which was set on the remote user interface but is not desired by the user to be used for display on the client PC, in other words, this sometimes makes it impossible to cause the client PC to perform appropriate display.

### SUMMARY OF THE INVENTION

The present invention provides an image processing apparatus that is capable of causing a client terminal to perform appropriate display based on setting information of a user stored in the image processing apparatus, a method of controlling the image processing apparatus, and a storage medium.

In a first aspect of the present invention, there is provided an image processing apparatus that transmits Web page information to a client terminal used by a user based on access from the client terminal, comprising a display unit configured to display an operation screen, a storage unit configured to store setting information set by each user concerning display on the display unit, and a transmission control unit configured to generate the Web page information based on setting information associated with the user out of the stored setting information and transmit the generated Web page information to the client terminal, based on access from the client terminal used by the user.

In a second aspect of the present invention, there is provided a method of controlling an image processing apparatus that transmits Web page information to a client terminal used by a user based on access from the client terminal, comprising displaying an operation screen, storing setting information set by each user concerning display on the operation screen, and generating the Web page information based on setting information associated with the user out of the stored setting information and transmitting the generated Web page information to the client terminal, based on access from the client terminal used by the user.

In a third aspect of the present invention, there is provided a non-transitory computer-readable storage medium storing a computer-executable program for executing a method of controlling an image processing apparatus that transmits Web page information to a client terminal used by a user based on access from the client terminal, wherein the method comprises displaying an operation screen, storing setting information set by each user concerning display on the operation screen, and generating the Web page information based on setting information associated with the user out of the stored setting information and transmitting the generated Web page information to the client terminal, based on access from the client terminal used by the user.

According to the present invention, based on access from the client terminal used by a user, Web page information is generated based on an item of setting information concerning display, which is associated with the user, out of stored items of setting information of respective users, and the generated Web page information is transmitted to the client terminal. This makes it possible for the client terminal to perform appropriate display according to the Web page information generated based on the stored item of setting information of the user.

Further features of the present invention will become apparent from the following description of exemplary embodiments (with reference to the attached drawings).

### BRIEF DESCRIPTION OF THE DRAWINGS

FIG. 1 is a schematic block diagram of an image processing system including an image processing apparatus according to an embodiment of the invention.

FIG. 2 is a schematic block diagram of the image processing apparatus appearing in FIG. 1.

FIG. 3 is a diagram useful in explaining various component elements used in a language setting process performed by the image processing system shown in FIG. 1.

FIG. 4 is a diagram useful in explaining authentication data used in the image processing apparatus appearing in FIG. 1.

FIG. 5 is a diagram useful in explaining setting data used in a setting data management section appearing in FIG. 3.

FIG. 6 is a diagram useful in explaining a language content file used in a remote user interface application appearing in FIG. 3.

FIG. 7 is a diagram useful in explaining a language resource file used in a device controller appearing in FIG. 3.

FIG. 8 is a flowchart of a language setting process performed by the image processing apparatus appearing in FIG. 1 using the device controller.

FIG. 9A is a flowchart of a language setting process performed by the image processing apparatus appearing in FIG. 1 using the remote user interface application.

FIG. 9B is a continuation of FIG. 9A.

FIG. 10A is a flowchart of a first variation of the language setting process performed by the image processing apparatus appearing in FIG. 1 using the remote user interface application.

FIG. 10B is a continuation of FIG. 10A.

FIG. 11A is a flowchart of a second variation of the language setting process performed by the image processing apparatus appearing in FIG. 1 using the remote user interface application.

FIG. 11B is a continuation of FIG. 11A.

### DESCRIPTION OF THE EMBODIMENTS

The invention will now be described in detail below with reference to the accompanying drawings showing embodiments thereof.

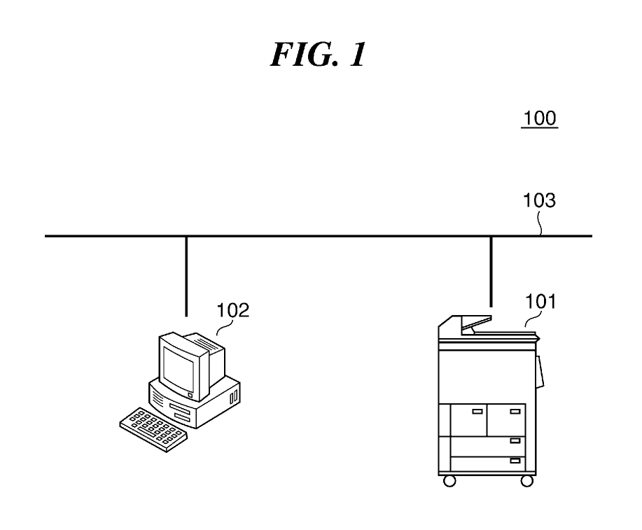

FIG. 1 is a schematic block diagram of an image processing system 100 including an image processing apparatus 101 according to an embodiment of the invention.

Referring to FIG. 1, the image processing system 100 includes the image processing apparatus 101 and a client terminal 102 which are connected to each other via a LAN (Local Area Network) 103. The image processing apparatus 101 may be connected to the client terminal 102 via a network including the Internet in place of the LAN 103 or via network including the Internet connected to the LAN 103. The image processing apparatus 101 is equipped with functions for performing image formation processing, such as scanning and printing, and prints an image on a sheet as a recording medium, based on scanned image data. The image processing apparatus 101 includes a Web server (not shown). For example, when the image processing apparatus 101 is connected to the network formed by the Internet, the Web server provides a Web application operable from the client terminal 102 via the network. The client terminal 102 is equipped with a Web browser function for operating the Web application provided by the Web server of the image processing apparatus 101.

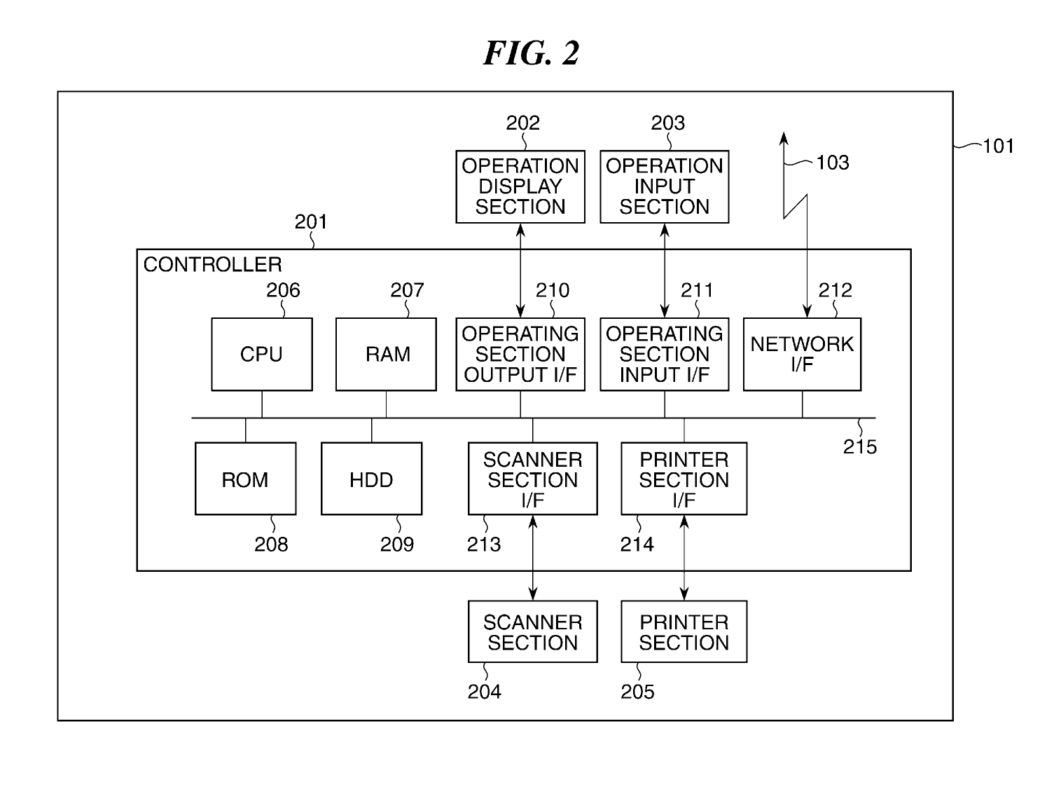

FIG. 2 is a schematic block diagram of the image processing apparatus 101 appearing in FIG. 1.

Referring to FIG. 2, the image processing apparatus 101 is comprised of a controller 201, an operation display section 202, an operation input section 203, a scanner section 204, and a printer section 205. The controller 201 includes a CPU 206, a RAM 207, a ROM 208, an HDD 209, an operating section output interface 210, an operating section input interface 211, a network interface 212, a scanner section interface 213, and a printer section interface 214, which are connected to each other via a bus 215.

The operation display section 202, the operation input section 203, the scanner section 204, the printer section 205, and the LAN 103 are connected to the controller 201. The controller 201 controls the components connected thereto. The CPU 206 starts an OS (Operating System) based on a boot program stored in the ROM 208, executes control programs stored in the HDD 209 on the started OS, and performs control processing using the RAM 207 as a work area. The HDD 209 stores various control programs used by the CPU 206, image data read by the scanner section 204, and various data acquired via the network interface 212. The operating section output interface 210 transmits display control data to the operation display section 202 according to a control signal transmitted from the CPU 206. The operating section input interface 211 receives information input by a user from the operation input section 203 and transmits the received information to the CPU 206. The network interface 212 performs data communication e.g. with the client terminal 102 connected thereto via the LAN 103. The scanner section interface 213 performs data communication with the scanner section 204, for receiving image data read by the scanner section 204 from the scanner section 204, and transmitting control data used in scanning to the scanner section 204. The printer section interface 214 performs data communication with the printer section 205, e.g. for transmitting image data, and control data used in printing, to the printer section 205. The operation display section 202 includes a display section including an LCD (liquid crystal display), LEDs (light emitting diodes) and so forth. The operation input section 203 includes a touch panel, hard keys, and like other input sections. The user inputs instructions for performing various operations using the touch panel and hard keys of the operation input section 203. The scanner section 204 includes an optical reading section, such as a CCD (charged coupled device), and reads image data by scanning sheets including images. The printer section 205 prints image data on sheets or the like as a recording medium.

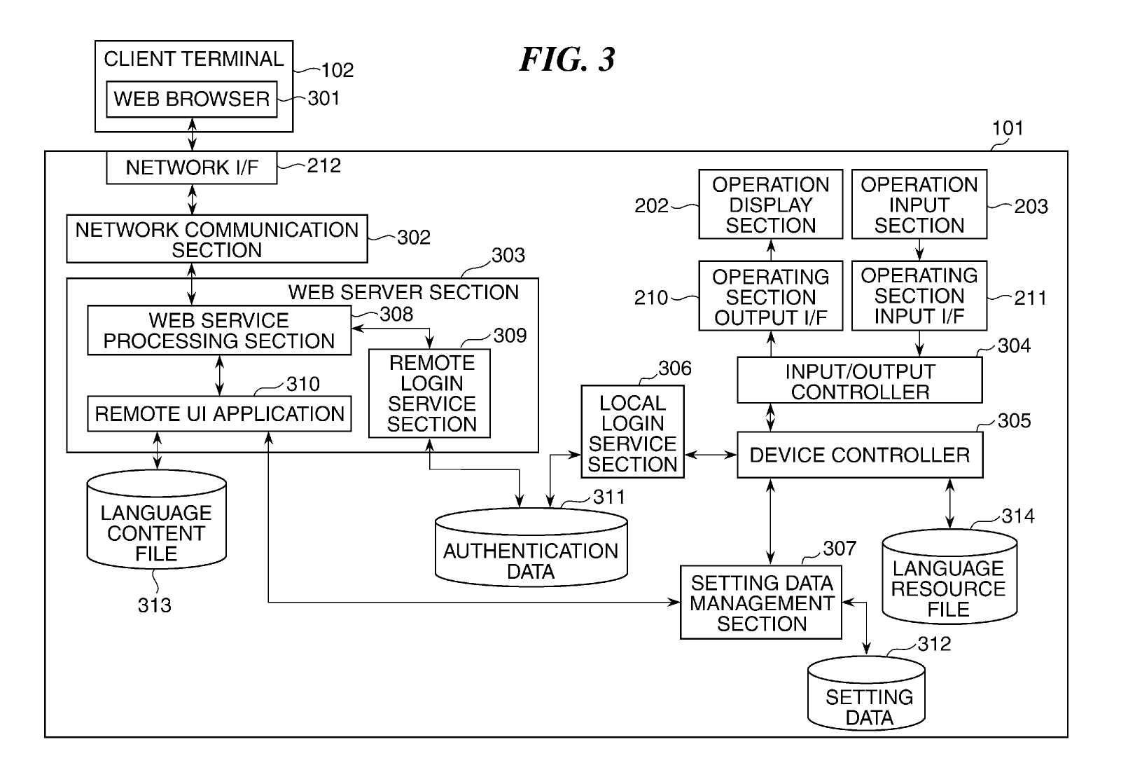

FIG. 3 is a diagram useful in explaining various component elements used in a language setting process performed by the image processing system 100 shown in FIG. 1.

Referring to FIG. 3, the image processing apparatus 101 performs the language setting process using hardware, such as the operation display section 202, the operation input section 203, the operating section output interface 210, the operating section input interface 211, and the network interface 212, described above with reference to FIG. 2, as well as components of software realized by programs executed by the CPU 206, including a network communication section 302, a Web server section 303, an input/output controller 304, a device controller 305, a local login service section 306, and a setting data management section 307. The Web server section 303 includes a Web service processing section 308, a remote login service section 309, and a remote user interface application 310.

The client terminal 102 includes a Web browser 301. For example, when the user accesses the Web server section 303 of the image processing apparatus 101 using the Web browser 301 of the client terminal 102, images associated with various Web services provided by the Web server section 303 are displayed on a screen of the client terminal 102. On the client terminal 102, various settings, such as a setting of a language to be used for display on the screen of the client terminal 102, a setting of the size of characters to be displayed on the screen, and a setting of inversion of colors to be displayed on the same, are made by the user using the client terminal 102. Information on the settings made by the user (hereinafter referred to as “user setting information”) is stored in an HDD (not shown) together with user information of the client terminal 102, such as a user ID for identifying the user. The Web browser 301 transmits a request message including information for identifying a Web service designated by the user and user information, such as a user ID, to the Web server section 303, and receives data associated with the Web service from the Web server section 303. When the Web browser 301 causes an image associated with the Web service to be displayed on the screen of the client terminal 102 according to the received data, the user performs various operations of the image processing apparatus 101 using the displayed Web service. Further, the Web browser 301 sets a language to be used for display on the screen of the client terminal 102 based on the user setting information stored in the HDD (not shown) and the data transmitted from the Web server section 303. Information on the language set by the Web browser 301 is transmitted as a request message to the Web server section 303 of the image processing apparatus 101. The request message includes the information on the language set by the Web browser 301 as Accept-Language http header information, which is header information of the browser.

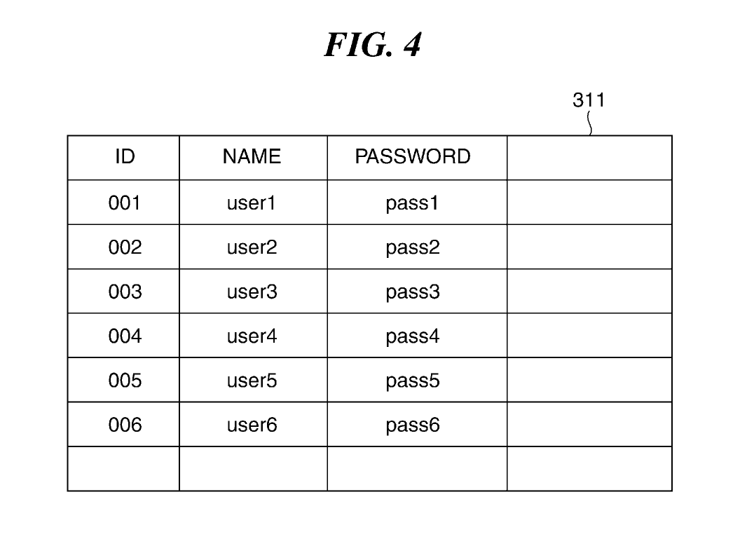

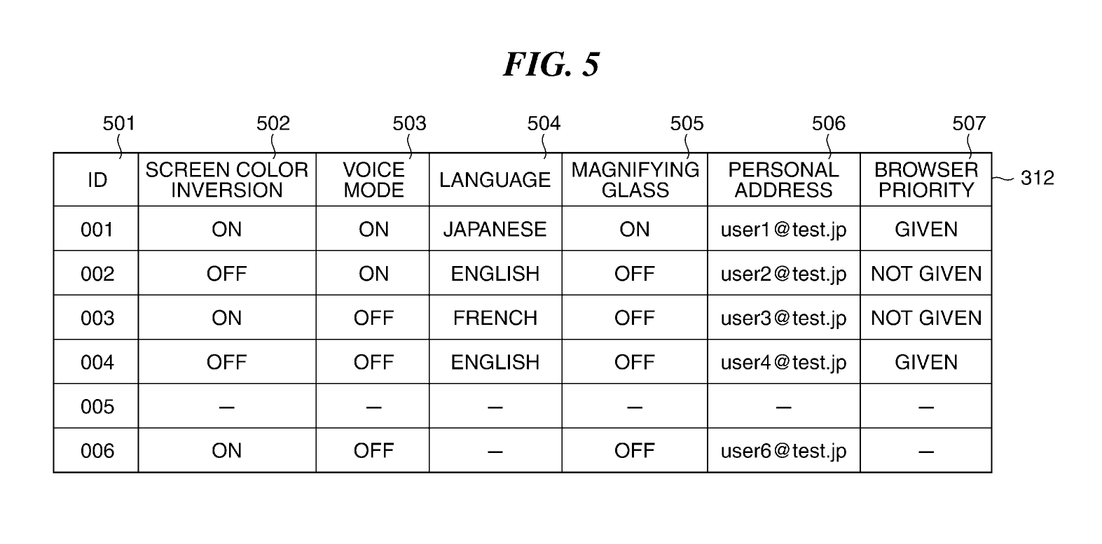

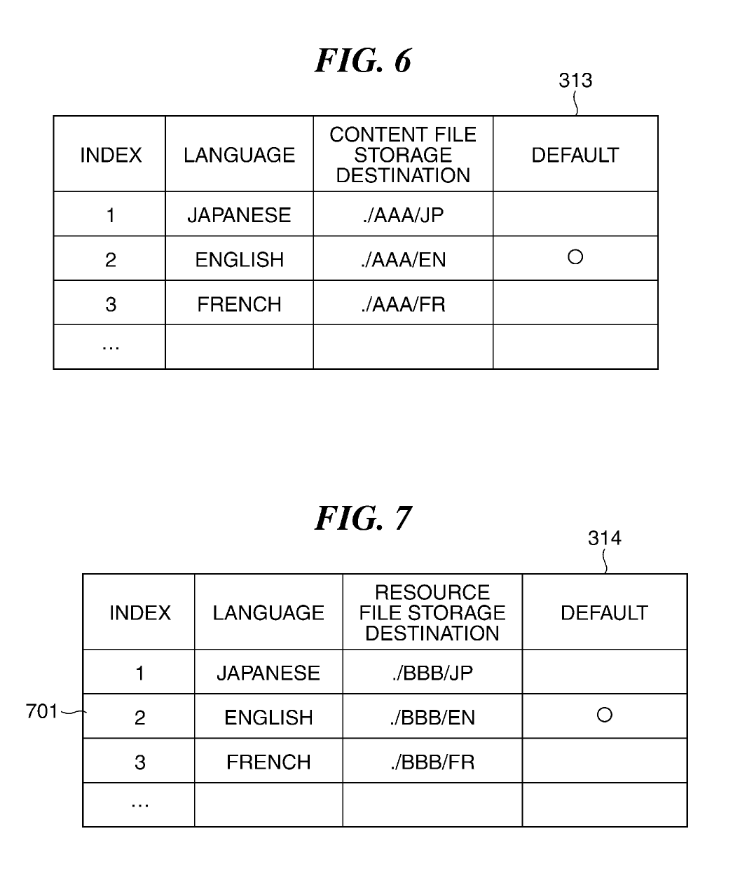

The network communication section 302 performs data communication between the Web browser 301 and the Web server section 303 via the network interface 212. The Web server section 303 provides various Web services according to request messages transmitted from the Web browser 301. The Web service processing section 308 determines an application associated with a Web service indicated by a request message transmitted from the Web browser 301. More specifically, the Web service processing section 308 receives and analyzes a request message including URL information, various parameter information, and cookie information, and identifies a Web service requested by the user. The Web service processing section 308 determines an application associated with the identified user request, and transmits data associated with the determined application to the Web browser 301. Further, the Web service processing section 308 transmits the request message and user information transmitted from the Web browser 301 to the remote user interface application 310. The remote login service section 309 generates display data for user authentication, and transmits the generated display data to the Web browser 301. Further, the remote login service section 309 performs user authentication based on information on the user transmitted from the Web browser 301, and authentication data 311, set in advance, shown in FIG. 4. The remote user interface application 310 sets a language to be used for display on the screen of the client terminal 102 according to the request message transmitted from the Web service processing section 308, generates display data according to the set language, and transmits the generated display data to the Web browser 301. In the present embodiment, the remote user interface application 310 sets a language to be used for display on the screen of the client terminal 102, according to setting data 312 shown in FIG. 5, which indicates user setting information set by each user. Further, the remote user interface application 310 acquires a content file, associated with the set language, based on a language content file 313 shown in FIG. 6, which is stored in advance in the RAM 207 and the HDD 209, and generates e.g. display data of an HTML (Hyper Text Markup Language) format.

The input/output controller 304 displays display data generated by the device controller 305, described hereinafter, on the operation display section 202 via the operating section output interface 210. On the other hand, the input/output controller 304 receives an operation instruction input by the user using the operation input section 203, via the operating section input interface 211. The device controller 305 generates display data to be displayed on an operation screen of the image processing apparatus 101, according to an instruction for generating the display data, which is transmitted from the input/output controller 304. The device controller 305 sets a language to be used for display on the operation screen of the image processing apparatus 101, according to the setting data 312 shown in FIG. 5. Further, the device controller 305 acquires a resource file associated with the set language, based on a language resource file 314, shown in FIG. 7, which is stored in advance in the RAM 207 and the HDD 209, generates display data e.g. in a bitmap format, based on the acquired resource file, and transmits the generated display data to the input/output controller 304. The local login service section 306 performs user authentication in the process performed by the device controller 305. The local login service section 306 acquires information input by the user using the operation input section 203, and performs user authentication based on the acquired information and the authentication data 311. The setting data management section 307 manages user setting information set by each user of the image processing apparatus 101 as the setting data 312.

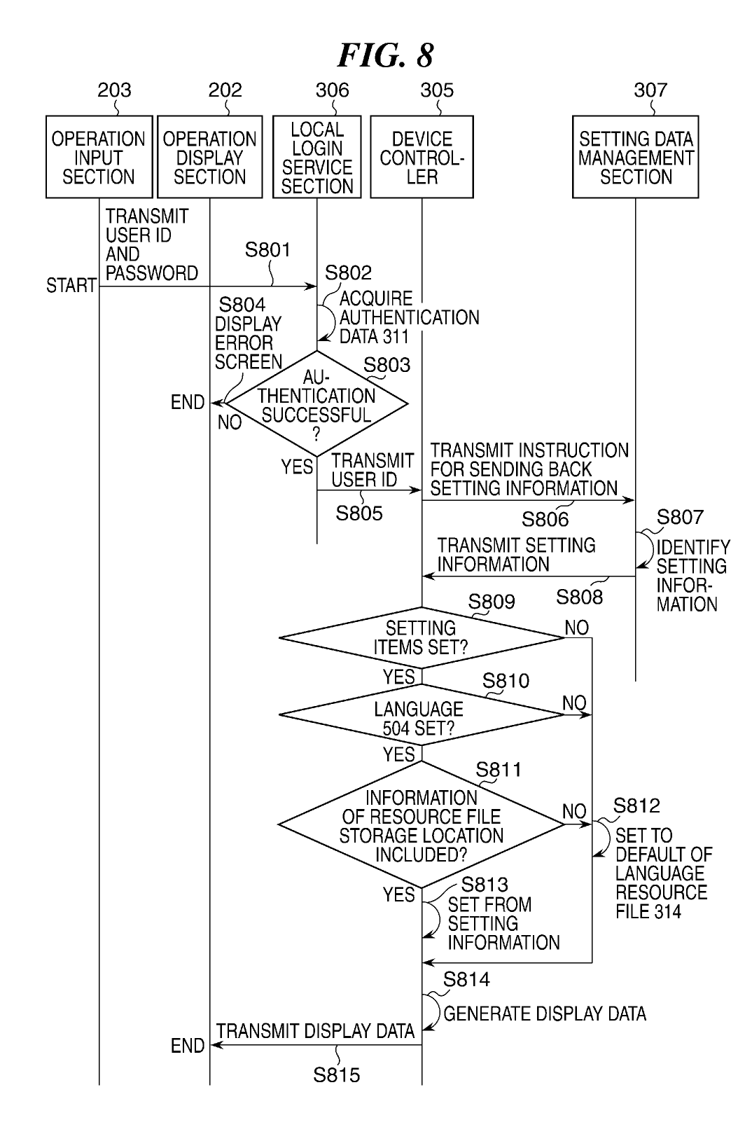

FIG. 8 is a flowchart of a language setting process performed by the device controller 305 of the image processing apparatus 101 appearing in FIG. 1.

The language setting process shown in FIG. 8 is performed by the CPU 206 which executes a control program stored in the HDD 209.

In the language setting process in FIG. 8, first, when the user inputs a user ID and a password to the operation input section 203, the operation input section 203 transmits the input user ID and password to the local login service section 306 (step S801). Next, the local login service section 306 acquires the authentication data 311 having user information registered therein in advance (step S802). Then, the local login service section 306 determines whether or not to authenticate user, based on the user ID, the password, and the authentication data 311 (step S803). More specifically, in the step S803, the local login service section 306 checks a match between each piece of user information registered in the authentication data 311 and the user ID and password received in the step S801. As a result of the checking, if the user information includes a piece of user information that matches the user ID and the password, the user authentication is successful, whereas if not, the user authentication fails.

If it is determined in the step S803 that the user authentication by the local login service section 306 has failed, the operation display section 202 displays a screen indicating a login error according to a display instruction transmitted from the local login service section 306 (step S804), followed by terminating the present process.

If it is determined in the step S803 that the user authentication by the local login service section 306 is successful, the local login service section 306 transmits the user ID as identification information for identifying the user to the device controller 305 (step S805). Next, the device controller 305 transmits the user ID received in the step S805 and an instruction for sending back user setting information associated with the user ID, to the setting data management section 307 (step S806). Then, the setting data management section 307 identifies the user setting information associated with the user ID received in the step S806, from the setting data 312 having the user setting information of each user set therein (step S807). Here, as shown in FIG. 5, the setting data 312 includes a setting item of “ID” 501 indicating information for identifying a user, “screen color inversion” 502 indicating a setting as to whether or not to invert colors to be displayed on the operation display section 202, “voice mode” 503 indicating a setting as to whether or not to enable a voice key operation function and a voice generation operation function, “language” 504 indicating a setting of a language to be used for display on the operation display section 202, “magnifying glass” 505 indicating a setting as to whether or not to enable a function for magnifying display on the operation display section 202, “personal address” 506 indicating a setting of an E-mail address of each user, and “browser priority” 507 which is a setting item indicating whether or not priority is given to information on a language set by the Web browser 301.

Then, the setting data management section 307 transmits the identified user setting information to the device controller 305 (step S808). Then, the device controller 305 determines whether or not the user setting information received in the step S808 has setting items thereof set (step S809). In the step S809, e.g. if none of the setting items are set, but “-” is indicated for each of them, as in user setting information of an ID 005 in FIG. 5, it is determined that the user setting information received in the step S808 has no setting items set.

If it is determined in the step S809 that the user setting information received in the step S808 has any setting item set, the device controller 305 determines whether or not the user setting information received in the step S808 has the language 504 set (step S810).

If it is determined in the step S810 that the user setting information received in the step S808 has the language 504 set, the device controller 305 determines whether or not the language resource file 314 stored in advance in the RAM 207 includes information indicative of a storage location of a resource file associated with information on the language 504 of the user setting information received in the step S808 (step S811). Here, the resource file is a bitmap file used for generating display data which is transmitted to the operation display section 202, and is stored in a manner associated with each language.

If it is determined in the step S809 that the user setting information received in the step S808 has no setting items set, if it is determined in the step S810 that the user setting information received in the step S808 does not have the language 504 set, or if it is determined in the step S811 that the language resource file 314 does not include the information indicative of the storage location of the resource file associated with the information on the language 504 of the user setting information received in the step S808, the device controller 305 sets a language to be used for display on the operation display section 202 based on a default setting of the language resource file 314 (step S812), and proceeds to a step S814. Here, in the language resource file 314, an item of “default” of an item group 701 including “index” 2 has a circle indicating a default setting added thereto, as appearing in FIG. 7. Thus, in the step S812, English which is a language for “index” 2 is set as the language to be used for display on the operation display section 202.

If it is determined in the step S811 that the language resource file 314 includes the information indicative of the storage location of the resource file associated with the information on the language 504 of the user setting information received in the step S808, the device controller 305 sets the language to be used for display on the operation display section 202 based on the information on the language 504 of the user setting information received in the step S808 (step S813).

Then, the device controller 305 acquires a resource file associated with the set language from the language resource file 314, and generates display data to be displayed on the operation display section 202 based on the acquired resource file (step S814). Next, the device controller 305 transmits the generated display data to the operation display section 202 (step S815), followed by terminating the present process.

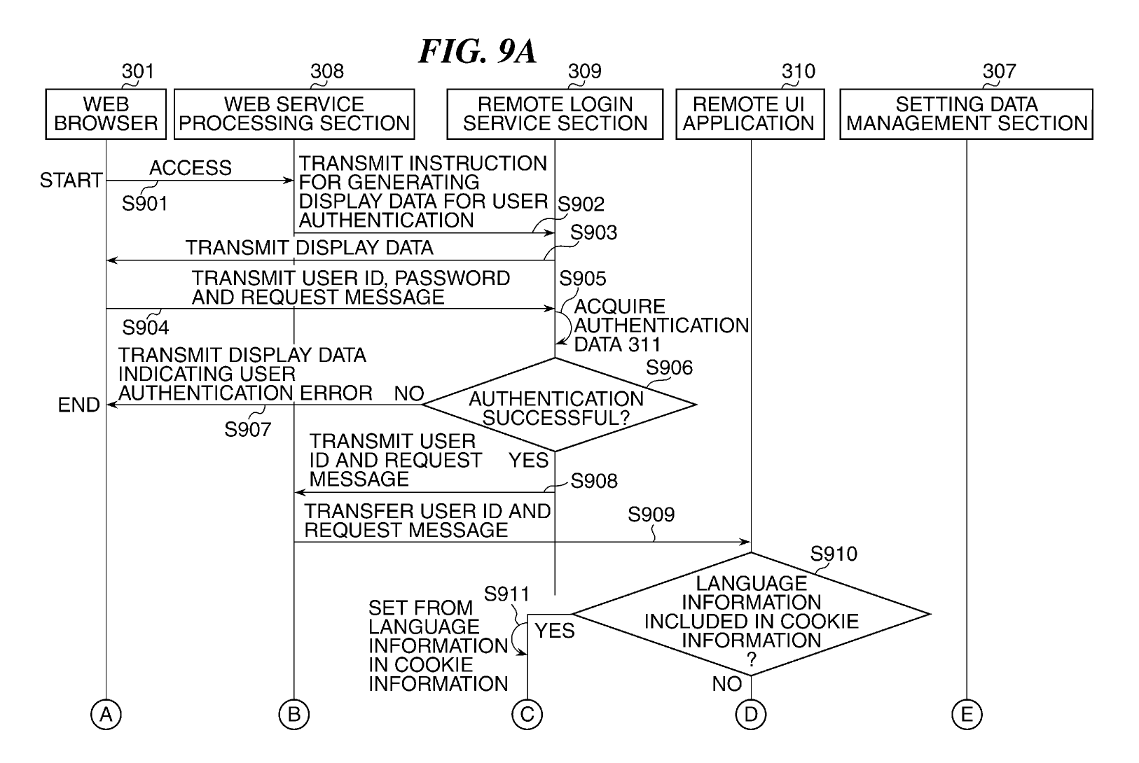

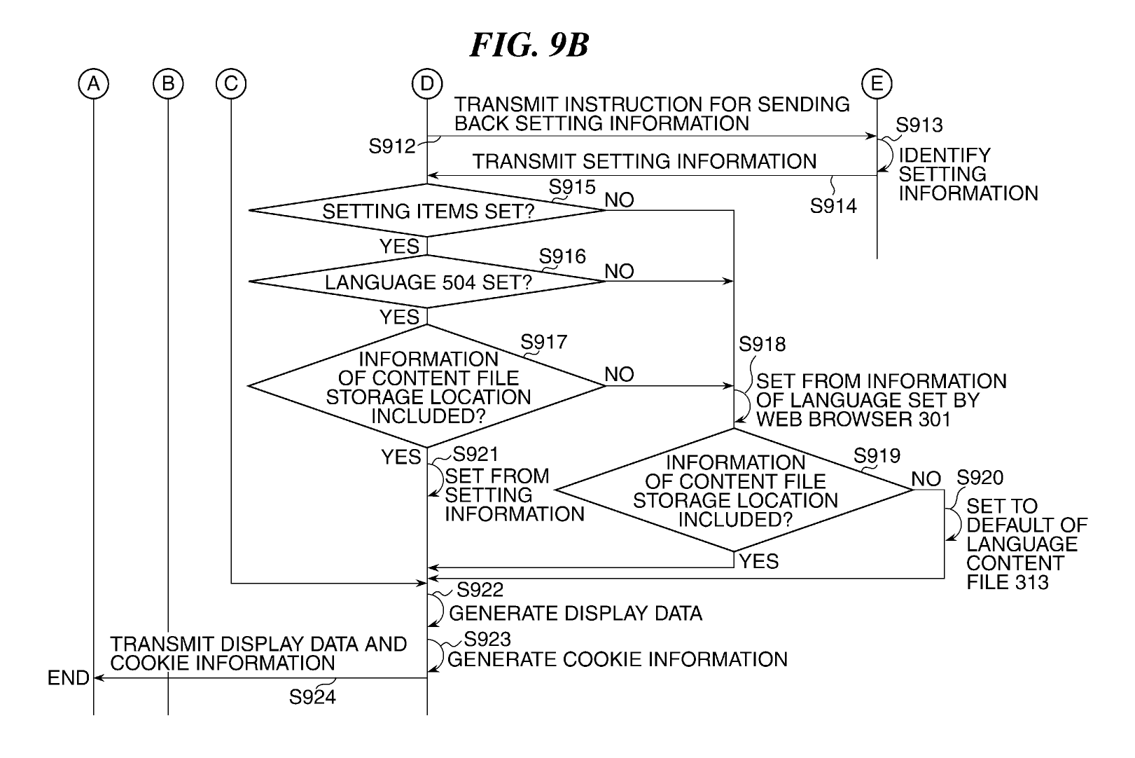

FIGS. 9A and 9B are a flowchart of a language setting process performed by the image processing apparatus 101 appearing in FIG. 1 using the remote user interface application 310.

The language setting process shown in FIGS. 9A and 9B is performed by the CPU 206 which executes a control program stored in the HDD 209.

The setting data 312 set in advance and information used for generation of display data by the remote user interface application 310, i.e. the information on the language set by the Web browser 301 are not associated with each other. Therefore, for example, in a case where a language set according to the setting data 312 is different from a language set according to the information on the language set by the Web browser 301, when the user accesses the image processing apparatus 101 from the client terminal 102, priority is given to the information set by the Web browser 301, whereby it is impossible to use the user setting information set in the setting data 312. This sometimes causes information on a language which is not desired by the user, i.e. the language set by the Web browser 301, to be used for display on the screen of the client terminal 102.

To cope with this, in the process shown in FIGS. 9A and 9B, the device controller 305 acquires user setting information associated with the authenticated user, and sets a language to be used for display on the screen of the client terminal 102 based on the acquired user setting information.

More specifically, first, when the user accesses the Web service processing section 308 using the Web browser 301 of the client terminal 102 (step S901), the Web service processing section 308 transmits an instruction for generating display data for user authentication to the remote login service section 309 (step S902). The remote login service section 309 generates the display data for user authentication according to the instruction received in the step S902, and transmits the generated display data to the Web browser 301 (step S903). Next, the Web browser 301 acquires a request message including the user ID and password input by the user, and information for identifying the Web service designated by the user (operation of an acquisition unit), and transmits the acquired request message to the remote login service section 309 (step S904). Here, the request message includes e.g. URL information, various parameters, Accept-Language http header information, and cookie information. Then, the remote login service section 309 acquires the authentication data 311 having the user information registered therein in advance (operation of a storage unit) (step S905). Then, the remote login service section 309 determines, based on the user ID, the password, and the authentication data 311, whether or not the user is successfully authenticated (step S906) (operation of an authentication unit). In the step S906, the remote login service section 309 checks a match between each piece of user information registered in the authentication data 311 and the user ID and password received in the step S904. As a result of the checking, if the user information includes a piece of user information that matches the user ID and the password, the user authentication is successful, whereas if not, the user authentication fails.

If it is determined in the step S906 that the user authentication by the remote login service section 309 has failed, the remote login service section 309 generates display data indicative of a user authentication error, and transmits the generated display data to the Web browser 301 (step S907), followed by terminating the present process.

If it is determined in the step S906 that the user authentication by the remote login service section 309 is successful, the remote login service section 309 transmits the user ID as identification information for identifying the user, the Accept-Language http header information in the request message, and the cookie information in the request message, to the Web service processing section 308 (step S908). Next, the Web service processing section 308 transfers the user ID, the Accept-Language http header information in the request message, and the cookie information in the request message, which have been received in step S908, to the remote user interface application 310 (step S909). Then, the remote user interface application 310 determines whether or not information for identifying a set language is included in the cookie information received in the step S909 (step S910). In the present embodiment, in a step S923, referred to hereinafter, cookie information including information indicative of the language set as a language to be used for display on the screen of the client terminal 102 is generated, and the generated cookie information is transmitted to the Web browser 301. The transmitted cookie information is stored in the client terminal 102 via the Web browser 301.

If it is determined in the step S910 that the information for identifying the set language is included in the cookie information received in the step S909, the remote user interface application 310 sets the language to be used for display on the screen of the client terminal 102 based on the information for identifying the set language, which is included in the cookie information (step S911), and proceeds to a step S922, referred to hereinafter.

If it is determined in the step S910 that the information for identifying the set language is not included in the cookie information received in the step S909, the remote user interface application 310 transmits the user ID received in the step S909 and an instruction for sending back user setting information associated with the user ID, to the setting data management section 307 (step S912). The setting data management section 307 identifies, from the setting data 312, the user setting information associated with the user ID received in the step S912 (step S913). Then, the setting data management section 307 transmits the identified user setting information to the remote user interface application 310 (step S914). The remote user interface application 310 determines whether or not the user setting information received in the step S914 has setting items thereof set (step S915). In the step S915, e.g. if none of the setting items are set, but “-” is indicated for each of them, as in the user setting information of the ID 005 in FIG. 5, it is determined that the user setting information received in the step S914 has no setting items set.

If it is determined in the step S915 that the user setting information received in the step S914 has any setting item set, the remote user interface application 310 determines whether or not the language 504 of the user setting information received in the step S914 is set (step S916).

If it is determined in the step S916 that the user setting information received in the step S914 has the language 504 set, the remote user interface application 310 determines whether or not the language content file 313 stored in advance in the RAM 207 includes information indicative of a storage location of a content file associated with information on the language 504 of the user setting information received in the step S914 (step S917). Here, the content file is an HTML file used for generating display data transmitted to the Web browser 301, and is stored in a manner associated with each language.

If it is determined in the step S915 that the user setting information received in the step S914 has no setting items set, if it is determined in the step S916 that the user setting information received in the step S914 does not have the language 504 set, or if it is determined in the step S917 that the language content file 313 does not include the information indicative of the storage location of the content file associated with the information on the language 504 of the user setting information received in the step S914, the remote user interface application 310 acquires the information on the language set by the Web browser 301, and sets a language to be used for display on the screen of the client terminal 102 based on the acquired information on the language set by the Web browser 301 (step S918). Here, the remote user interface application 310 acquires the information on the language set by the Web browser 301 based on the Accept-Language http header information in the request message received in the step S909. Note that as described above, the Accept-Language http header information includes the information indicative of the language set by the Web browser 301.

Then, the remote user interface application 310 determines whether or not the language content file 313 includes information indicative of a storage location of a content file associated with the information on the language set by the Web browser 301, which has been acquired in the step S918 (step S919).

If it is determined in the step S919 that the language content file 313 includes the information indicative of the storage location of the content file associated with the information on the language set by the Web browser 301, which has been acquired in the step S918, the remote user interface application 310 proceeds to the step S922.

If it is determined in the step S919 that the language content file 313 does not include the information indicative of the storage location of the content file associated with the information on the language set by the Web browser 301, which has been acquired in the step S918, the remote user interface application 310 sets a language to be used for display on the screen of the client terminal 102 based on a default setting of the language content file 313 (step S920), and proceeds to the step S922. Here, in the language content file 313, an item of “default” of an item group 601 including “index” 2 has a circle indicating a default setting added thereto, as appearing in FIG. 6. Thus, in the step S920, English is set as the language to be used for display on the screen of the client terminal 102.

If it is determined in the step S917 that the language content file 313 includes the information indicative of the storage location of the content file associated with the information on the language 504 of the user setting information received in the step S914, the remote user interface application 310 sets a language to be used for display on the screen of the client terminal 102 based on the user setting information received in the step S914 (step S921). Then, the remote user interface application 310 acquires a content file associated with the set language, from the language content file 313, and generates display data to be displayed on the screen of the client terminal 102 (Web page information) based on the acquired content file (step S922). Next, the remote user interface application 310 generates cookie information including information indicative of the set language (Web page information) (step S923), and transmits the generated display data and cookie information to the Web browser 301 (step S924) (operation of a transmission control unit), followed by terminating the present process.

According to the language setting process shown in FIGS. 9A and 9B, in the image processing apparatus 101, cookie information and display data are generated based on access from the client terminal 102 operated by the user, based on the user setting information of the setting data 312, which is associated with the user, and the generated cookie information and display data are transmitted to the client terminal 102. Therefore, the user setting information set in advance by the user is given priority over information on the language set by the Web browser 301, and the language based on the cookie information including information indicative of the language set in advance by the user is used for display on the client terminal 102. This makes it possible to perform appropriate display based on the user setting information stored in the image processing apparatus 101.

Further, in the language setting process shown in FIGS. 9A and 9B, the remote user interface application 310 transmits cookie information including information indicative of the set language to the Web browser 301. Therefore, the cookie information transmitted from the remote user interface application 310 based on a first access from the Web browser 301 is referred to by the user when the user makes a second access from the Web browser 301, whereby it is possible to easily identify the language set as the language to be used for display on the screen of the client terminal 102 when the first access was made.

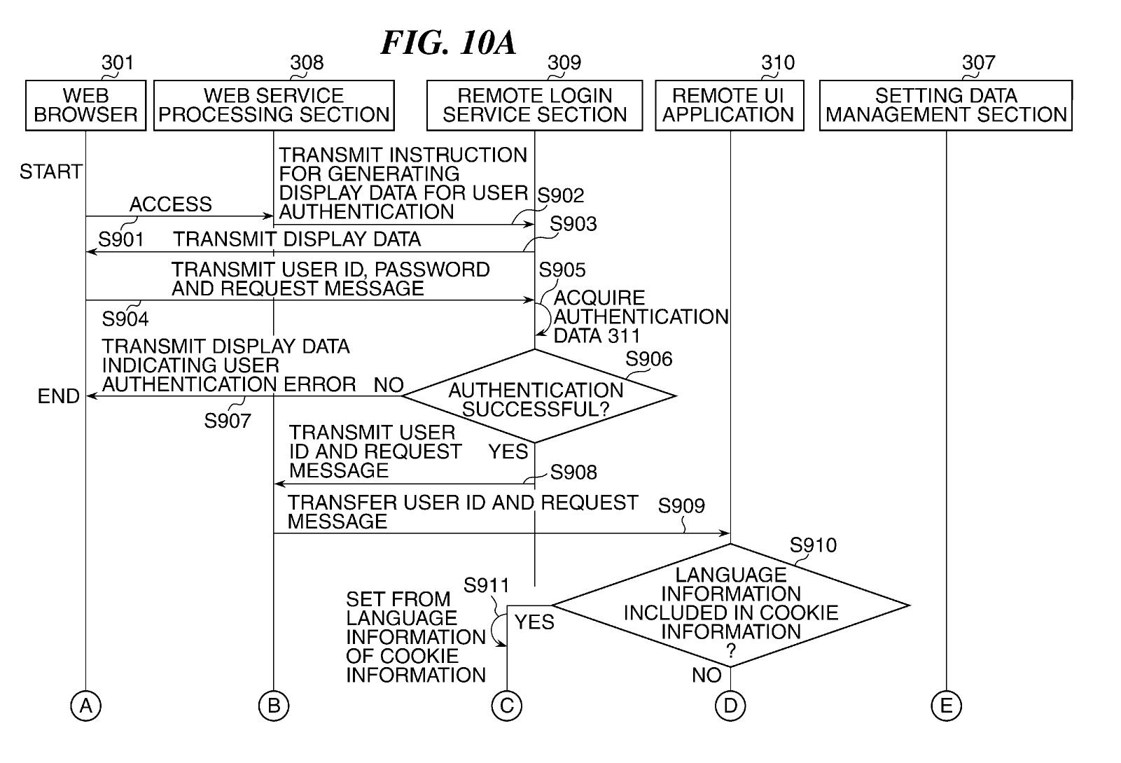

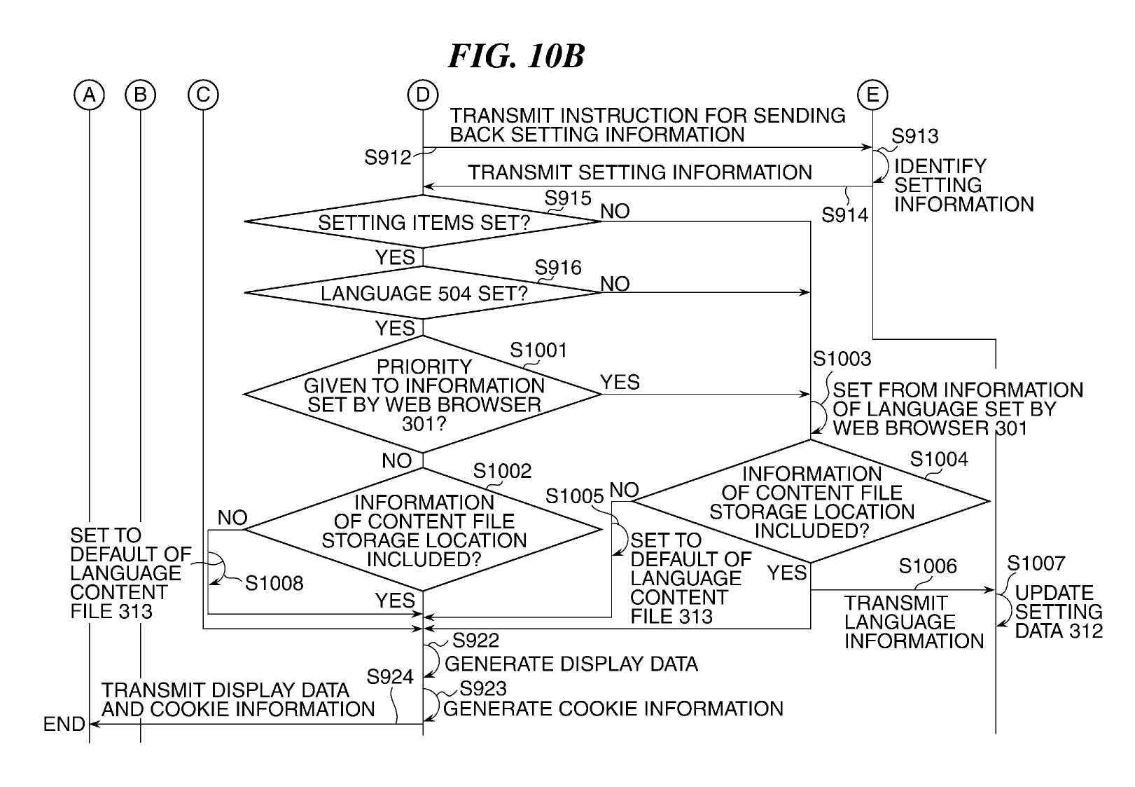

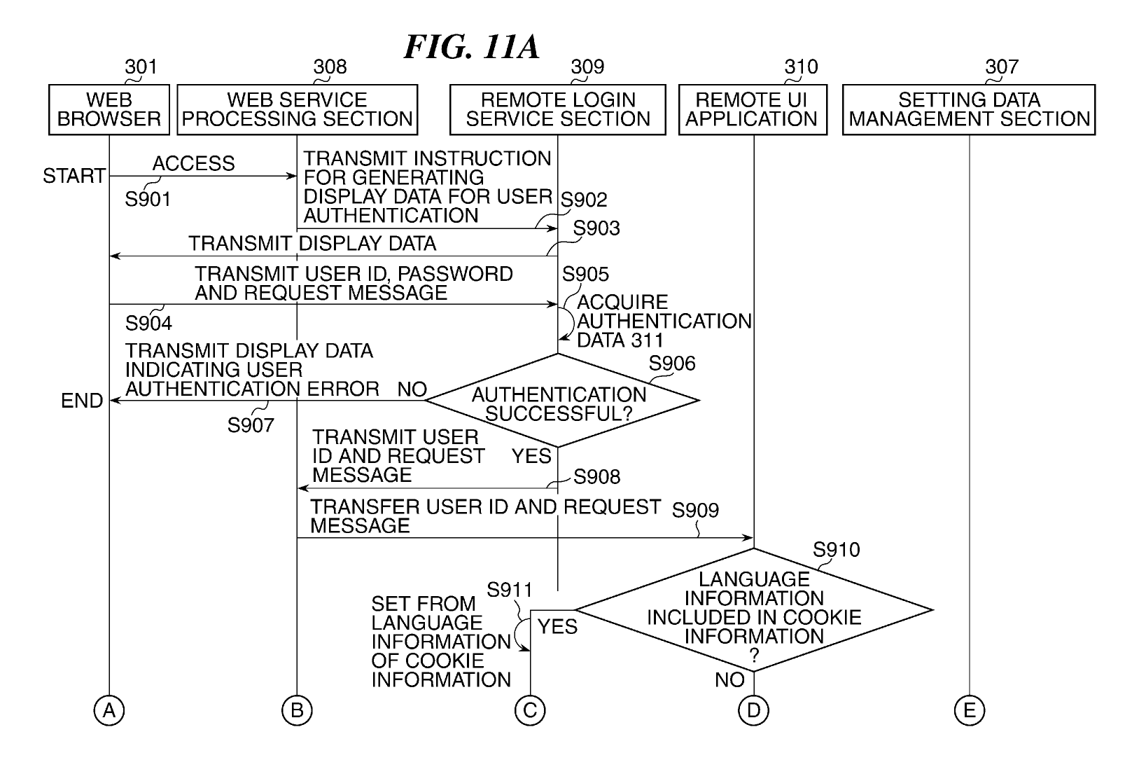

Although in the language setting process in FIGS. 9A and 9B described above, the language to be used for display on the screen of the client terminal 102 is set according to only a result of authentication of the user, as shown in FIGS. 10A and 10B, the language to be used for display on the screen of the client terminal 102 may be set based on information indicating which of the user setting information of the setting data 312 and information on the language set by the Web browser 301 should be given priority.

FIGS. 10A and 10B are a flowchart of a first variation of the language setting process performed by the image processing apparatus 101 appearing in FIG. 1 using the remote user interface application 310.

The first variation is performed by the CPU 206 which executes a control program stored in the HDD 209.

In the present variation, first, the same processing as in the steps S901 to S916 in FIGS. 9A and 9B is performed. If it is determined in the step S916 that the user setting information received in the step S914 has the language 504 set, the remote user interface application 310 determines, based on the user setting information received in the step S914, whether or not to set a language to be used for display on the screen of the client terminal 102 using the information on the language set by the Web browser 301 (step S1001).

That is, in the present variation, when setting the language to be used for display on the screen of the client terminal 102, it is determined in the step S1001 which of the user setting information of the setting data 312 and the information on the language set by the Web browser 301 is to be used (operation of a determination unit). More specifically, in the step S1001, the determination is performed based on setting information of the browser priority 507 of the user setting information. In the user setting information, in a case where the language to be used for display on the screen of the client terminal 102 is to be set using the information on the language set by the Web browser 301, “given” is set for the browser priority 507. On the other hand, in a case where the language to be used for display on the screen of the client terminal 102 is not to be set using the information on the language set by the Web browser 301, “not given” is set for the browser priority 507.

If it is determined in the step S915 that the user setting information received in the step S914 has no setting items set, if it is determined in the step S916 that the user setting information received in the step S914 does not have the language 504 set, or if it is determined in the step S1001 that the language to be used for display on the screen of the client terminal 102 is to be set using the information on the language set by the Web browser 301, the remote user interface application 310 acquires the information on the language set by the Web browser 301, and sets the language to be used for display on the screen of the client terminal 102 based on the acquired information on the language set by the Web browser 301 (step S1003). Here, the remote user interface application 310 acquires the information on the language set by the Web browser 301 based on the Accept-Language http header information in the request message received in the step S909.

Then, the remote user interface application 310 determines whether or not the language content file 313 includes information indicative of a storage location of a content file associated with the information on the language set by the Web browser 301, which has been acquired in the step S1003 (step S1004).

If it is determined in the step S1004 that the language content file 313 includes the information indicative of the storage location of the content file associated with the information on the language set by the Web browser 301, which has been acquired in the step S1003, the remote user interface application 310 proceeds to the step S922. On the other hand, the remote user interface application 310 transmits the language information set in the step S1003 and the user ID to the setting data management section 307 (step S1006). Next, the setting data management section 307 updates the setting data 312 based on the language information and the user ID received in the step S1006 (step S1007) (operation of an update unit). More specifically, in the setting data 312, information on the language 504 associated with information of the ID 501 which matches the user ID transmitted from the remote user interface application 310 in the step S1006 is changed into the language information set in the step S1003. This makes it possible to save the user time and effort from having to update the user setting information of the setting data 312.

If it is determined in the step S1004 that the language content file 313 does not include the information indicative of the storage location of the content file associated with the information on the language set by the Web browser 301, which has been acquired in the step S1003, the remote user interface application 310 sets the language to be used for display on the screen of the client terminal 102 based on the default setting of the language content file 313 (step S1005), and proceeds to the step S922.

If it is determined in the step S1001 that the language to be used for display on the screen of the client terminal 102 is not to be set using the information on the language set by the Web browser 301, the remote user interface application 310 determines whether or not the language content file 313 includes information indicative of a storage location of a content file associated with the information on the language 504 of the user setting information received in the step S914 (step S1002).

If it is determined in the step S1002 that the language content file 313 does not include the information indicative of the storage location of the content file associated with the information on the language 504 of the user setting information received in the step S914, the remote user interface application 310 sets the language to be used for display on the screen of the client terminal 102 based on the default setting of the language content file 313 (step S1008), and proceeds to the step S922.

If it is determined in the step S1002 that the language content file 313 includes the information indicative of the storage location of the content file associated with the information on the language 504 of the user setting information received in the step S914, the remote user interface application 310 performs the same processing as in the steps S922 to S924 in FIG. 9B, followed by terminating the present process.

According to the present variation, when setting the language to be used for display on the screen of the client terminal 102, it is determined, based on information on the browser priority 507 of the user setting information of the setting data 312, which of the user setting information of the setting data 312 and the information on the language set by the Web browser 301 is to be used, and the language to be used for display is set based on the determination. Consequently, by setting the information of the browser priority 507 appearing in FIG. 5 to “not given”, which means that the information on the language set by the Web browser 301 is not to be used, so as to increase the priority of the user setting information of the setting data 312, it is possible to positively display a language desired by the user on the client terminal 102.

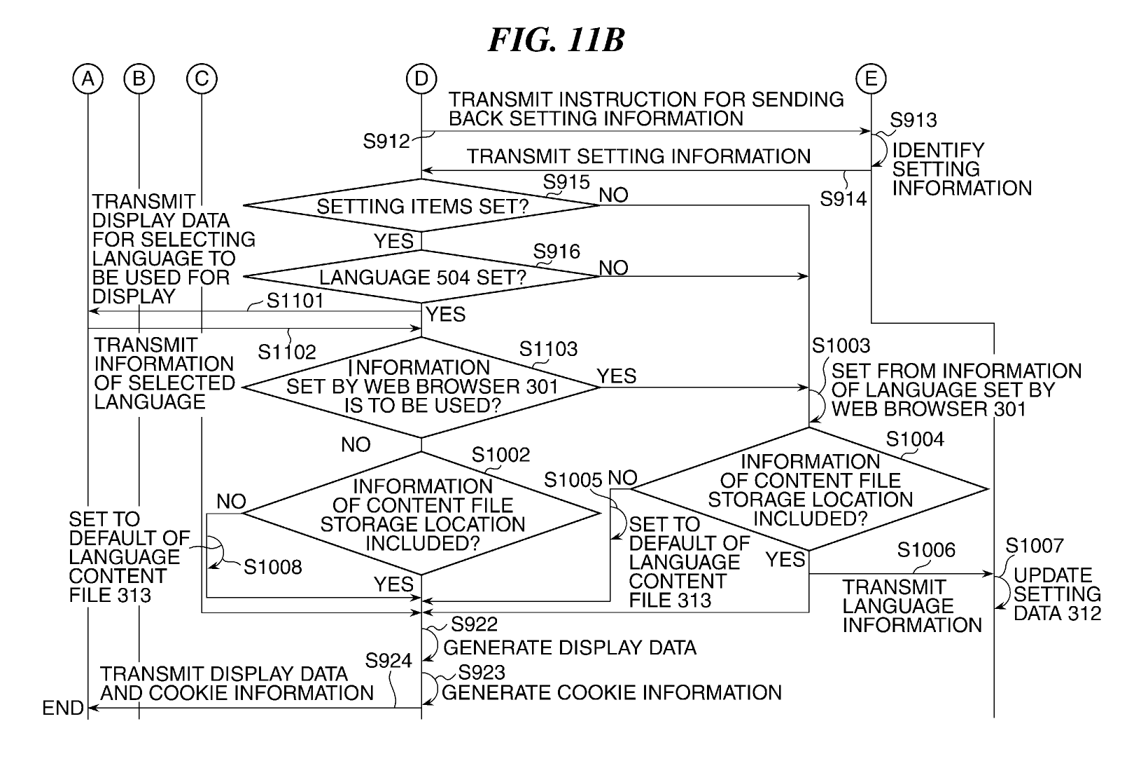

Alternatively, as described hereafter with reference to FIGS. 11A and 11B, the user may use the Web browser 301 to select which of the user setting information of the setting data 312 and the information on the language set by the Web browser 301 is to be used, and set the language to be used for display on the screen of the client terminal 102 based on the selection.

FIGS. 11A and 11B are a flowchart of a second variation of the language setting process performed by the image processing apparatus 101 appearing in FIG. 1 using the remote user interface application 310.

The second variation is performed by the CPU 206 which executes a control program stored in the HDD 209.

In the present variation, first, the same processing as in the steps S901 to S916 in FIGS. 9A and 9B is performed. If it is determined in the step S916 that the user setting information received in the step S914 has the language 504 set, the remote user interface application 310 generates display data from which the user can select a language to be used for display on the screen of the client terminal 102, and transmits the generated display data to the Web browser 301 (step S1101). On the screen of the client terminal 102, an image for prompting the user to select which of the user setting information of the setting data 312 and the information on the language set by the Web browser 301 is to be used is displayed based on the display data transmitted from the remote user interface application 310 in the step S1101 (operation of a selection unit). Next, the Web browser 301 transmits information indicative of a user-selected language to the remote user interface application 310 (step S1102). Next, when setting a language to be used for display, based on the information indicative of the user-selected language, which has been received in the step S1102, the remote user interface application 310 determines which of the user setting information of the setting data 312 and the information on the language set by the Web browser 301 is to be used (step S1103).

If it is determined in the step S915 that the user setting information transmitted from the setting data management section 307 to the remote user interface application 310 in the step S914 has no setting items not, if it is determined in the step S916 that the user setting information transmitted in the step S914 does not have the language 504 set, or if it is determined in the step S1103 that the information on the language set by the Web browser 301 is to be used, the same processing as in the steps S1003 to S1007 in FIG. 10B is performed, followed by terminating the present process.

If it is determined in the step S1103 that the information on the language set by the Web browser 301 is not to be used, in other words, if it is determined that, when setting a language to be used for display, the user setting information of the setting data 312 is to be used, the same processing as in the steps S1002, S1008, and S922 to S924 in FIG. 10B is performed, followed by terminating the present process.

According to the present variation, whether the user setting information of the setting data 312 is to be used or the information on the language set by the Web browser 301 is to be used is selected, and, when setting a language to be used for display, based on the selected information, it is determined which of the user setting information of the setting data 312 and the information on the language set by the Web browser 301 is to be used. Therefore, by selecting the use of the user setting information of the setting data 312, it is possible to positively display the language desired by the user on the client terminal 102.

In the step S1007 in the variations of the language setting processes shown in FIGS. 10A and 10B and 11A and 11B, before updating the setting data 312, the user may select, for example, using the Web browser 301 whether or not to update the setting data 312, and it may be determined based on the selection whether or not to update the setting data 312 (operation of an update determination unit). This makes it possible for the user to positively manage the update of the setting data 312.

Although in the above described embodiment, the description has been given of a case where the present embodiment is applied to the setting of a language in the user setting information, the present embodiment may be applied to other settings of the user setting information, such as a setting of a character size on the screen, and a setting of inversion of colors displayed on the screen.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-186228 filed Sep. 12, 2014 which is hereby incorporated by reference herein in its entirety.

What is claimed is:

1. An image processing apparatus that transmits Web page information to a client terminal used by a user based on access from the client terminal, comprising:
a display unit configured to display an operation screen;
a storage unit configured to store setting information set by each user concerning display on said display unit; and
a transmission control unit configured to generate the Web page information based on setting information associated with the user out of the stored setting information and transmit the generated Web page information to the client terminal, based on access from the client terminal used by the user.

2. The image processing apparatus according to claim 1, comprising an authentication unit configured to authenticate the user, and
wherein said transmission control unit generates the Web page information based on setting information associated with the authenticated user out of the stored setting information and transmits the generated Web page information to the client terminal, based on access from the client terminal used by the user.

3. The image processing apparatus according to claim 1, wherein the setting information is setting information on a language.

4. The image processing apparatus according to claim 1, comprising:
an acquisition unit configured to acquire setting information concerning display in the client terminal; and
a determination unit configured to determine which of the acquired setting information and the setting information associated with the user is to be used, in a case where the acquired setting information and the setting information associated with the user are different from each other, and
wherein said transmission control unit generates the Web page information based on determination by said determination unit and transmits the generated Web page information to the client terminal, based on access from the client terminal used by the user.

5. The image processing apparatus according to claim 4, further comprising a selection unit configured to prompt the user to select which of the acquired setting information and the setting information associated with the user is to be used, in a case where the acquired setting information and the setting information associated with the user are different from each other.

6. The image processing apparatus according to claim 4, further comprising an update unit configured to update the setting information associated with the user to the acquired setting information, in a case where the Web page information is generated based on the acquired setting information, and the generated Web page information is transmitted to the client terminal.

7. The image processing apparatus according to claim 6, further comprising an update determination unit configured to determine whether or not to update the setting information associated with the user.

8. A method of controlling an image processing apparatus that transmits Web page information to a client terminal used by a user based on access from the client terminal, comprising:
displaying an operation screen;
storing setting information set by each user concerning display on the operation screen; and
generating the Web page information based on setting information associated with the user out of the stored setting information and transmitting the generated Web page information to the client terminal, based on access from the client terminal used by the user.

9. A non-transitory computer-readable storage medium storing a computer-executable program for executing a method of controlling an image processing apparatus that transmits Web page information to a client terminal used by a user based on access from the client terminal,
wherein the method comprises:
displaying an operation screen;
storing setting information set by each user concerning display on the operation screen; and
generating the Web page information based on setting information associated with the user out of the stored setting information and transmitting the generated Web page information to the client terminal, based on access from the client terminal used by the user.
